(19) United States
(12) Patent Application Publication
(10) Pub. No.: US 2003/0093329 A1
(43) Pub. Date: May 15, 2003

(54) Method and apparatus for recommending items of interest based on preferences of a selected third party

(75) Inventor: Srinivas Gutta, Yorktown Heights, NY (US)

Correspondence Address: Corporate Patent Counsel, U.S. Philps Corporation, 580 White Plains Road, Tarrytown, NY, 10591, US

(73) Assignee: Koninklijke Philips Electronics N.V.

(21) Appl. No.: 10/014,202

(22) Filed: Nov. 13, 2001

(51) Int. Cl. G06F 17/60

(52) U.S. Cl. 705/26

(57) ABSTRACT

A method and apparatus are disclosed for recommending items of interest to a user, such as television program recommendations, based on the viewing or purchase history of a selected third party. A viewing history of a selected third party is partitioned into a set of similar clusters. A given cluster corresponds to a segment of television programs exhibiting a specific pattern. A user can select one or more clusters from the clustered third party viewing history to supplement or replace corresponding portions (clusters) of the user's own viewing history to produce a modified viewing history. The modified viewing history is processed to generate a user profile that characterizes the viewing preferences of the user, as well as the selected viewing preferences of the third party. Program recommendations are generated using the modified user profile.

### CROSS-REFERENCE TO RELATED APPLICATIONS

The present invention is related to United States Patent Application entitled “Method and Apparatus for Evaluating the Closeness of Items in a Recommender of Such Items,” (Attorney Docket Number US010567), United States Patent Application entitled “Method and Apparatus for Partitioning a Plurality of Items into Groups of Similar Items in a Recommender of Such Items,” (Attorney Docket Number US010568), United States Patent Application entitled “Method and Apparatus for Generating A Stereotypical Profile for Recommending Items of Interest Using Item-Based Clustering,” (Attorney Docket Number US010569), United States Patent Application entitled “Method and Apparatus for Recommending Items of Interest Based on Stereotype Preferences of Third Parties,” (Attorney Docket Number US010575) and United States Patent Application entitled “Method and Apparatus for Generating a Stereotypical Profile for Recommending Items of Interest Using Feature-Based Clustering,” (Attorney Docket Number US010576), each filed contemporaneously herewith, assigned to the assignee of the present invention and incorporated by reference herein.

### FIELD OF THE INVENTION

The present invention relates to methods and apparatus for recommending items of interest, such as television programming, and more particularly, to techniques for recommending programs and other items of interest based on the preferences of a selected third party, such as a friend or colleague.

### BACKGROUND OF THE INVENTION

As the number of channels available to television viewers has increased, along with the diversity of the programming content available on such channels, it has become increasingly challenging for television viewers to identify television programs of interest. Electronic program guides (EPGs) identify available television programs, for example, by title, time, date and channel, and facilitate the identification of programs of interest by permitting the available television programs to be searched or sorted in accordance with personalized preferences.

A number of recommendation tools have been proposed or suggested for recommending television programming and other items of interest. Television program recommendation tools, for example, apply viewer preferences to an EPG to obtain a set of recommended programs that may be of interest to a particular viewer. Generally, television program recommendation tools obtain the viewer preferences using implicit or explicit techniques, or using some combination of the foregoing. Implicit television program recommendation tools generate television program recommendations based on information derived from the viewing history of the viewer, in a non-obtrusive manner. Explicit television program recommendation tools, on the other hand, explicitly question viewers about their preferences for program attributes, such as title, genre, actors, channel and date/time, to derive viewer profiles and generate recommendations.

When selecting an item of interest, individuals are often influenced by the selections made by others. For example, people who are viewed as “trendsetters” often influence the viewing or purchase habits of others. Online retailers, such as Amazon.com, employ collaborative filtering techniques to recommend additional items to a customer based on selections made by other people who purchased the same item. Thus, following the purchase of a product, a customer is often advised that other customers who purchased this product also purchased certain other products.

In addition, many individuals often wish that they had watched a television program that was watched by a friend or colleague. There is currently no mechanism, however, to recommend television programs or other items of interest based on the viewing or purchase history of a selected third party, such as a friend, colleague or trendsetter.

### SUMMARY OF THE INVENTION

Generally, a method and apparatus are disclosed for recommending items of interest to a user, such as television program recommendations, based on the viewing or purchase history of a selected third party. A viewing history of a selected third party is processed to partition the third party viewing history into a set of clusters that are similar to one another in some way. More specifically, a given cluster corresponds to a particular segment of television programs from the viewing history of the selected third party exhibiting a specific pattern.

A clustering routine partitions the third party viewing or purchase history (the data set) into clusters, such that points (e.g., television programs) in one cluster are closer to the mean of that cluster than any other cluster. A user can select one or more clusters from the clustered third party viewing history to supplement or replace corresponding portions (clusters) of the user's own viewing history to produce a modified viewing history. The modified viewing history is processed to generate a user profile that characterizes the viewing preferences of the user, as modified to reflect the viewing preferences of the selected third party. Program recommendations are generated using the modified user profile. Thus, the generated recommendations are based, at least in part, on the preferences of a selected third party.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram of a television program recommender in accordance with the present invention;

FIG. 2 is a sample table from an exemplary program database of FIG. 1;

FIG. 3 illustrates the clustered third party viewing history 130′ of FIG. 1 in further detail;

FIG. 4A is a sample table from a viewing history that has been modified in accordance with the present invention to include viewing preferences of at least one selected third party;

FIG. 4B is a sample tale from a viewer profile generated by an exemplary decision tree recommender from the modified viewing history of FIG. 4A;

FIG. 5 is a flow chart describing the clustering process of FIG. 1 embodying principles of the present invention;

FIG. 6 is a flow chart describing the view history modification process of FIG. 1 embodying principles of the present invention; and

FIG. 7 is a flow chart describing the program recommendation process of FIG. 1 embodying principles of the present invention.

### DETAILED DESCRIPTION

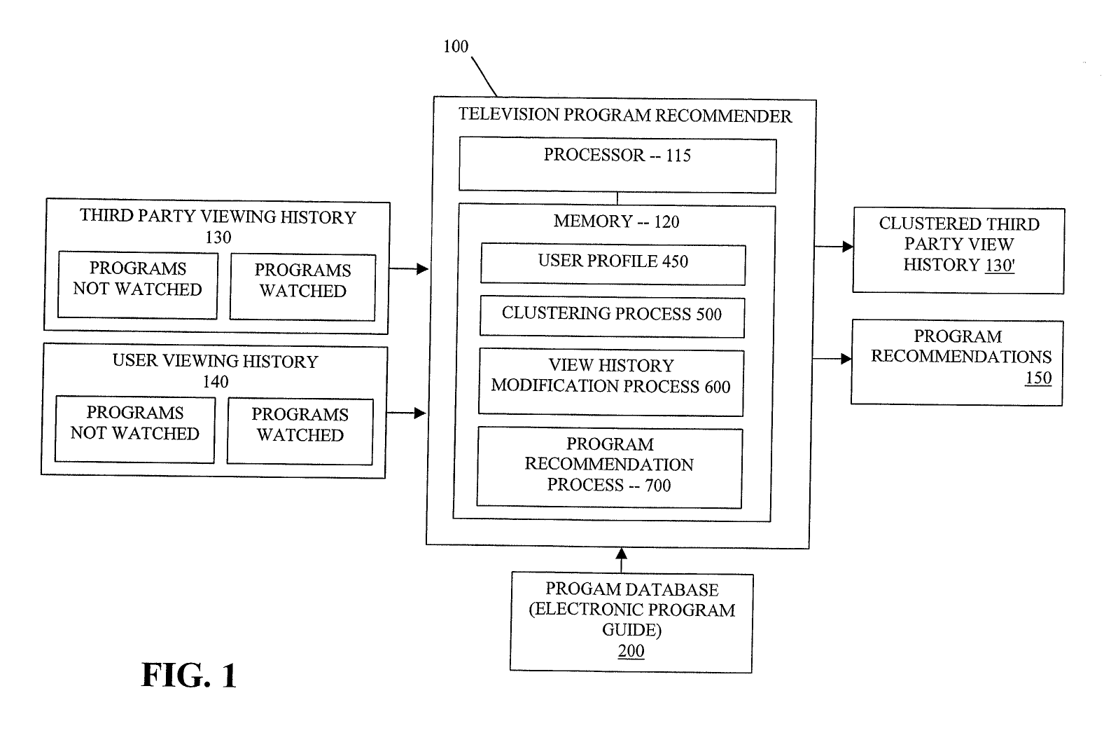

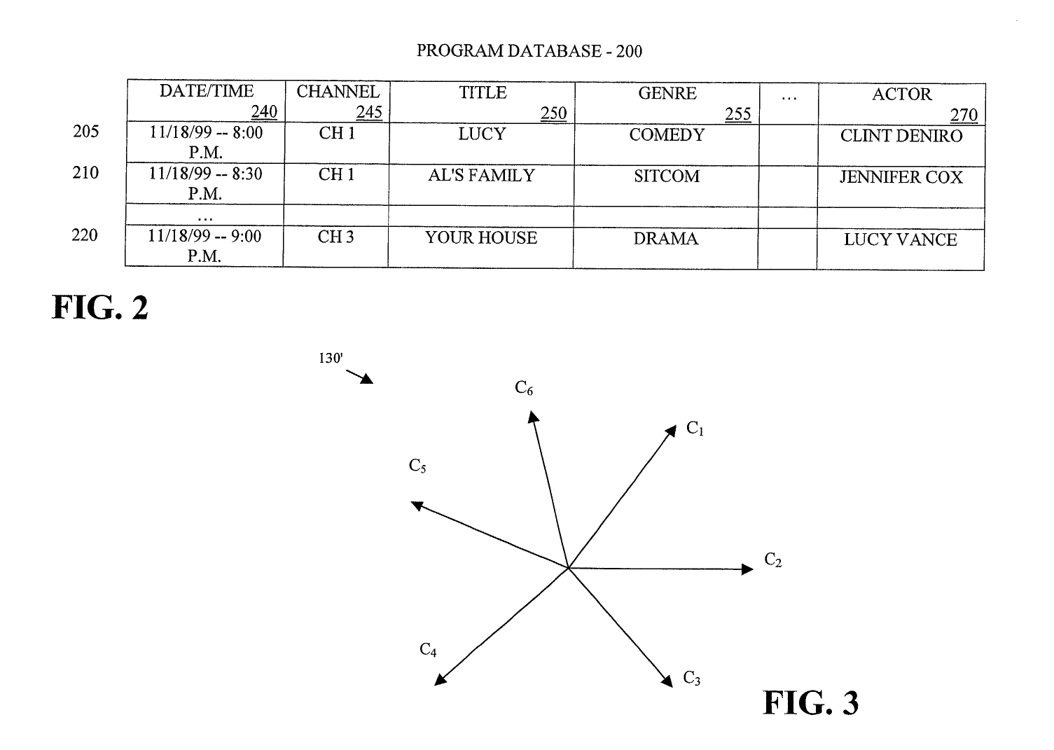

FIG. 1 illustrates a television programming recommender 100 in accordance with the present invention. As shown in FIG. 1, the exemplary television programming recommender 100 evaluates programs in a program database 200, discussed below in conjunction with FIG. 2, to identify programs of interest to a particular viewer. The set of recommended programs can be presented to the viewer, for example, using a set-top terminal/television (not shown) using well-known on-screen presentation techniques. While the present invention is illustrated herein in the context of television programming recommendations, the present invention can be applied to any automatically generated recommendations that are based on an evaluation of user behavior, such as a viewing history or a purchase history.

According to one feature of the present invention, the television programming recommender 100 can generate television program recommendations based, at least in part, on the viewing history 130 of a selected third party, such as a friend, colleague or trendsetter. According to another feature of the invention, the television programming recommender 100 processes the third party viewing history 130 to partition the third party viewing history 130 into a clustered third party viewing history 130′. As discussed further below, the clustered third party viewing history 130′ contains a number of clusters of television programs (data points) that are similar to one another in some way. Thus, a given cluster corresponds to a particular segment of television programs from the third party viewing history 130 exhibiting a specific pattern.

The third party viewing history 130 is processed in accordance with the present invention to generate the clustered third party viewing history 130′, with each cluster containing programs exhibiting some specific pattern. Thereafter, the user can select one or more clusters from the clustered third party viewing history 130′ to supplement or replace corresponding portions (clusters) of the user's own viewing history 140. The third party viewing history 130 and user viewing history 140 are each comprised of a set of programs that are watched and not watched by the respective user.

For example, the third party and user viewing histories 130, 140 may each contain a “drama” cluster, where most of the programs in the cluster are of the “drama” genre. Thus, a user can optionally select the drama cluster from the third party viewing history 130 to supplement or replace the drama cluster from the user's own viewing history 140. In this manner, the actual programs from the drama cluster in the user's viewing history 140 will be replaced by (or supplemented with) the actual programs from the selected drama cluster in the third party viewing history 130.

The television program recommender 100 may be embodied as any computing device, such as a personal computer or workstation, that contains a processor 115, such as a central processing unit (CPU), and memory 120, such as RAM and/or ROM. The television program recommender 100 may also be embodied as an application specific integrated circuit (ASIC), for example, in a set-top terminal or display (not shown). In addition, the television programming recommender 100 may be embodied as any available television program recommender, such as the TivO™ system, commercially available from Tivo, Inc., of Sunnyvale, Calif., or the television program recommenders described in U.S. patent application Ser. No. 09/466,406, filed Dec. 17, 1999, entitled “Method and Apparatus for Recommending Television Programming Using Decision Trees,” U.S. patent application Ser. No. 09/498,271, filed Feb. 4, 2000, entitled “Bayesian TV Show Recommender,” and U.S. patent application Ser. No. 09/627,139, filed Jul. 27, 2000, entitled “Three-Way Media Recommendation Method and System,” or any combination thereof, as modified herein to carry out the features and functions of the present invention.

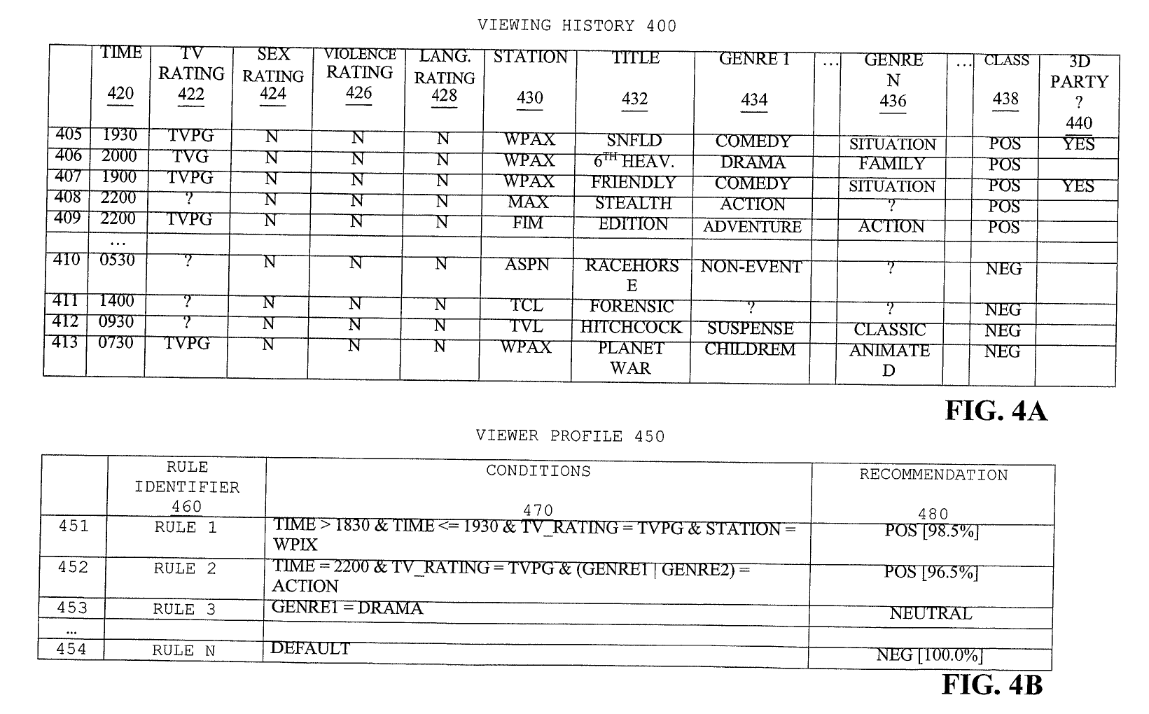

As shown in FIG. 1, and discussed further below in conjunction with FIGS. 2 through 7, the television programming recommender 100 includes a program database 200, a user profile 450, a clustering process 500, a view history modification process 600 and a program recommendation process 700. Generally, the program database 200 may be embodied as a well-known electronic program guide and records information for each program that is available in a given time interval. One illustrative user profile 450, shown in FIG. 4B, is generated by a decision tree recommender, based on an exemplary modified viewing history 400, shown in FIG. 4A. The present invention permits the user viewing history 140 or portions thereof to be supplemented or replaced with selected portions of the clustered third party viewing history 130′ to create the modified viewing history 400 shown in FIG. 4A.

The clustering process 500 partitions the third party viewing history 130 (the data set) into clusters, such that points (television programs) in one cluster are closer to the mean (centroid) of that cluster than any other cluster. The view history modification process 600 allows a user to select one or more clusters from the third party viewing history 130 to supplement or replace corresponding portions (clusters) of user's own viewing history 140. Finally, the program recommendation process 700 recommends programs of interest based, in part, on the selected portions of the clustered third party viewing history 130.

FIG. 2 is a sample table from the program database (EPG) 200 of FIG. 1. As previously indicated, the program database 200 records information for each program that is available in a given time interval. As shown in FIG. 2, the program database 200 contains a plurality of records, such as records 205 through 220, each associated with a given program. For each program, the program database 200 indicates the date/time and channel associated with the program in fields 240 and 245, respectively. In addition, the title, genre and actors for each program are identified in fields 250, 255 and 270, respectively. Additional well-known features (not shown), such as duration and description of the program, can also be included in the program database 200.

FIG. 3 illustrates the clustered third party viewing history 130′ of FIG. 1 in further detail. As previously indicated, the third party viewing history 130 is processed to partition the third party viewing history 130 into a clustered third party viewing history 130′. As shown in FIG. 3, the clustered third party viewing history 130′ contains a number of exemplary clusters C₁ through C₆ corresponding to a particular segment of television programs from the third party viewing history 130 exhibiting a specific pattern. Each cluster C₁ through C₆ can be assigned a label that characterizes the distinguishing features of the cluster. In addition, each cluster C₁ through C₆ selected by the user can be assigned a weight to prioritize the various clusters in a desired manner. In this manner, the user can select one or more clusters of interest from the clustered third party viewing history 130′ to supplement or replace corresponding portions (clusters) of the user's own viewing history 140. It is noted that the user viewing history 140 can be partitioned in the same manner as the clustered third party viewing history 130′ shown in FIG. 3.

FIG. 4A is a table illustrating an exemplary modified viewing history 400 that is maintained by an exemplary decision tree television recommender. It is noted that the modified viewing history 400 is based on the user viewing history 140, as modified by any selected portions of the clustered third party viewing history 130′. As shown in FIG. 4A, the modified viewing history 400 contains a plurality of records 405-413 each associated with a different program. In addition, for each program, the modified viewing history 400 identifies various program features in fields 420-440. The values set forth in fields 420-440 may be typically obtained from the electronic program guide 200. It is noted that if the electronic program guide 200 does not specify a given feature for a given program, the value is specified in the modified viewing history 400 using a “?”. In addition, field 440 of the modified viewing history 400 indicates whether the corresponding program comes from the viewing history 130 of a third party or the viewing history 140 of the user, in accordance with the present invention.

FIG. 4B is a table illustrating an exemplary viewer profile 450 that may be generated by a decision tree television recommender from the modified viewing history 400 set forth in FIG. 4A. As shown in FIG. 4B, the decision tree viewer profile 450 contains a plurality of records 451-454 each associated with a different rule specifying viewer preferences. In addition, for each rule identified in column 460, the viewer profile 450 identifies the conditions associated with the rule in field 470 and the corresponding recommendation in field 480.

For a more detailed discussion of the generating of viewer profiles in a decision tree recommendation system, see, for example, U.S. patent application Ser. No. 09/466,406, filed Dec. 17, 1999, entitled “Method and Apparatus for Recommending Television Programming Using Decision Trees,” incorporated by reference above.

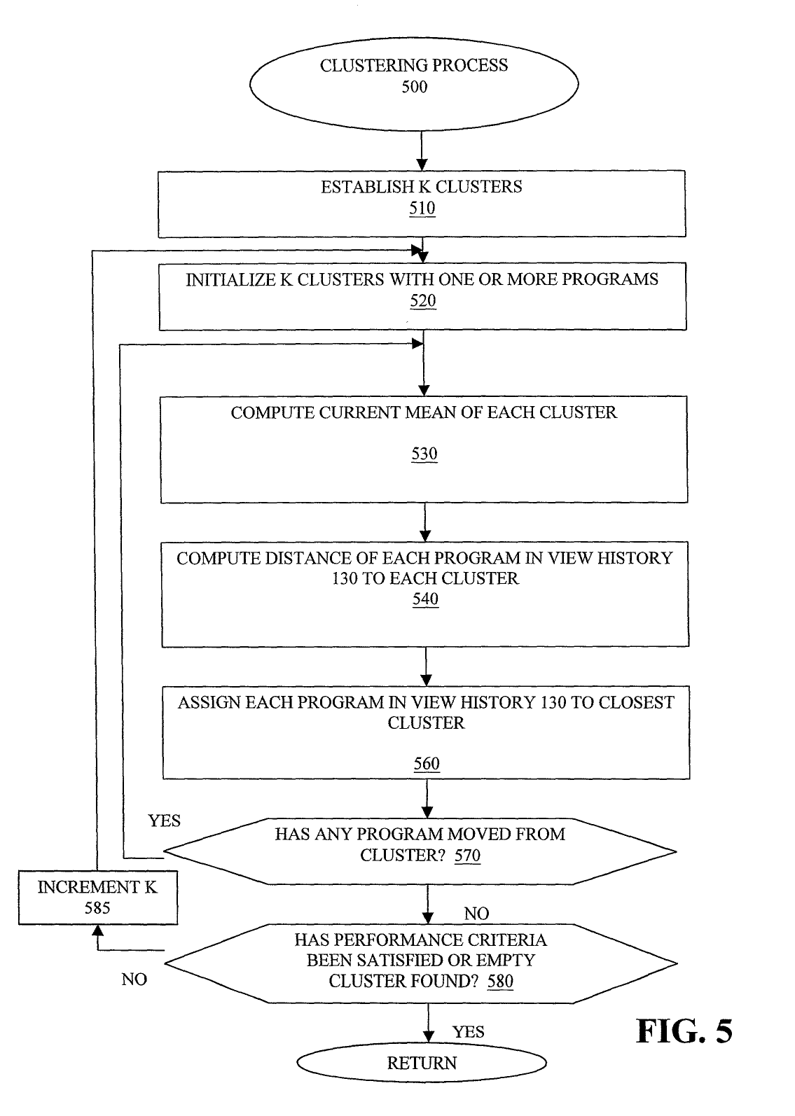

FIG. 5 is a flow chart describing an exemplary implementation of a clustering process 500 incorporating features of the present invention. As previously indicated, the clustering process 500 partitions the third party viewing history 130 (the data set) into clusters 130′, such that points (television programs) in one cluster are closer to the mean (centroid) of that cluster than any other cluster. Generally, clustering routines focus on the unsupervised task of finding groupings of examples in a sample data set. In an exemplary implementation, the clustering process 500 partitions a data set into k clusters using a k-means clustering algorithm. As discussed hereinafter, the two main parameters to the clustering process 500 are (i) the distance metric for finding the closest cluster; and (ii) k, the number of clusters to create.

The exemplary clustering process 500 employs a dynamic value of k, with the condition that a stable k has been reached when further clustering of example data does not yield any improvement in the classification accuracy. In addition, the cluster size is incremented to the point where an empty cluster is recorded. Thus, clustering stops when a natural level of clusters has been reached.

As shown in FIG. 5, the clustering process 500 initially establishes k clusters during step 510. The exemplary clustering process 500 starts by choosing a minimum number of clusters, say two. For this fixed number, the clustering process 500 processes the entire view history data set 130 and over several iterations, arrives at two clusters which can be considered stable (i.e., no programs would move from one cluster to another, even if the algorithm were to go through another iteration). The current k clusters are initialized during step 520 with one or more programs.

In one exemplary implementation, the clusters are initialized during step 520 with some seed programs selected from the third party viewing history 130. The program for initializing the clusters may be selected randomly or sequentially. In a sequential implementation, the clusters may be initialized with programs starting with the first program in the view history 130 or with programs starting at a random point in the view history 130. In yet another variation, the number of programs that initialize each cluster may also be varied. Finally, the clusters may be initialized with one or more “hypothetical” programs that are comprised of feature values randomly selected from the programs in the third party viewing history 130.

Thereafter, the clustering process 500 computes the current mean of each cluster during step 530. The clustering process 500 then determines the distance of each program in the third party viewing history 130 to each cluster during step 540. For a more detailed discussion of exemplary techniques for computing the current mean of each cluster (step 530) and determining the distance of each program to each cluster (step 540), see, for example, our contemporaneous United States Patent Application, entitled “Method and Apparatus for Recommending Items of Interest Based on Stereotype Preferences of Third Parties,” (Attorney Docket Number US010575), incorporated by reference herein. Each program in the viewing history 130 is then assigned during step 560 to the closest cluster.

A test is performed during step 570 to determine if any program has moved from one cluster to another. If it is determined during step 570 that a program has moved from one cluster to another, then program control returns to step 530 and continues in the manner described above until a stable set of clusters is identified. If, however, it is determined during step 570 that no program has moved from one cluster to another, then program control proceeds to step 580.

A further test is performed during step 580 to determine if a specified performance criteria has been satisfied or if an empty cluster is identified (collectively, the “stopping criteria”). If it is determined during step 580 that the stopping criteria has not been satisfied, then the value of k is incremented during step 585 and program control returns to step 420 and continues in the manner described above. If, however, it is determined during step 580 that the stopping criteria has been satisfied, then program control terminates.

The exemplary clustering process 500 employs a dynamic value of k, with the condition that a stable k has been reached when further clustering of example data does not yield any improvement in the classification accuracy. In addition, the cluster size is incremented to the point where an empty cluster is recorded. Thus, clustering stops when a natural level of clusters has been reached.

A subset of programs from the third party viewing history 130 (the test data set) can be used to test the classification accuracy of the clustering process 500. For each program in the test set, the closest cluster is identified and the class labels (watched or not watched) for the cluster and the program under consideration are compared. The percentage of matched class labels translates to the accuracy of the clustering process 500. The clustering process 500 will terminate if the classification accuracy has reached a predefined threshold.

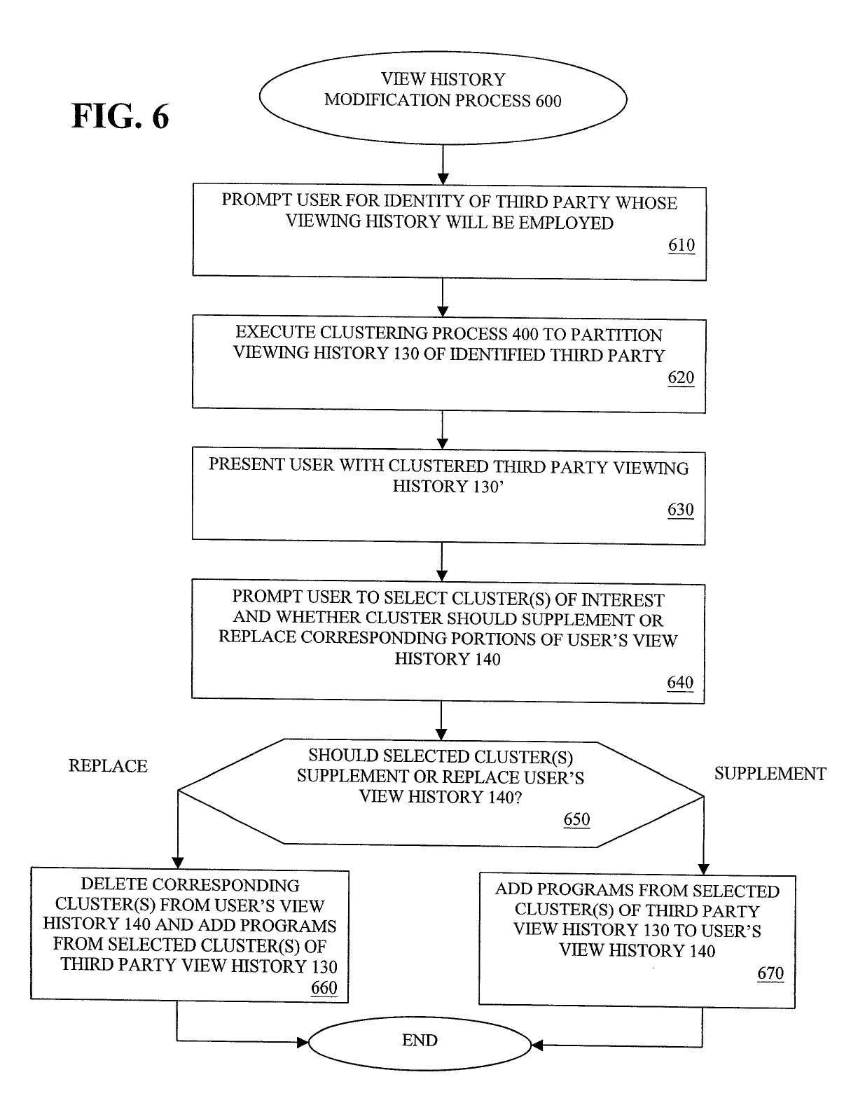

FIG. 6 is a flow chart describing an exemplary implementation of a view history modification process 600 incorporating features of the present invention. As previously indicated, the view history modification process 600 allows a user to select one or more clusters from the clustered third party viewing history 130′ to supplement or replace corresponding portions (clusters) of user's own viewing history 140.

As shown in FIG. 6, the view history modification process 600 initially prompts the user during step 610 for the identity of the third party whose viewing history will be employed, such as a friend, colleague or trendsetter. Thereafter, the view history modification process 600 executes the clustering process 400 during step 620 to partition the viewing history 130 of identified third party.

The user is presented with the clustered third party viewing history 130′ during step 630 and is prompted to select any cluster(s) of interest to supplement or replace corresponding portions of the user's view history 140 during step 640.

A test is performed during step 650 to determine if the selected cluster(s) should supplement or replace the user's view history 140. If it is determined during step 650 that the selected cluster(s) should replace the user's view history 140, then the corresponding cluster(s) of the user's view history 140 are deleted and the programs from the selected cluster(s) of the third party view history 130 are added to the user's view history 140 during step 660.

If, however, it is determined during step 650 that the selected cluster(s) should supplement the user's view history 140, then the programs from the selected cluster(s) of the third party view history 130 are added to the corresponding clusters of the user's view history 140 during step 670. Program control then terminates. The output of the view history modification process 600 is the modified viewing history 400 shown in FIG. 4A.

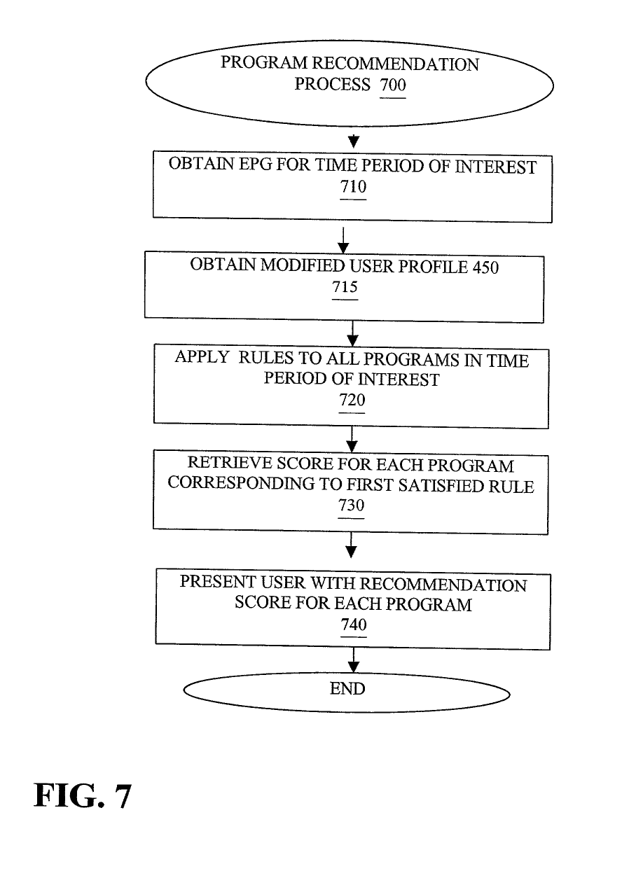

FIG. 7 is a flow chart describing an exemplary implementation of a program recommendation process 700 incorporating features of the present invention. As previously indicated, the program recommendation process 700 recommends programs of interest based, in part, on the selected portions of the clustered third party viewing history 130′. The recommendation process 700 utilizes the user profile 450 developed by the view history modification process 600 (based on the modified view history 400) to generate program recommendations based on the viewing history 130 of a selected third party. It is again noted that while the present invention is illustrated herein using a decision tree recommender, the present invention may be embodied using any recommender, including a Bayesian recommender, as would be apparent to a person of ordinary skill in the art.

As shown in FIG. 7, the recommendation process 700 initially obtains the electronic program guide (EPG) 200 during step 710 for the time period of interest. Thereafter, the modified viewer profile 450 is obtained for the viewer during step 715. The recommendation process 700 then applies the rules from the profile 450 to all the programs in the time period of interest during step 720. A score is retrieved for each program from field 480 of the profile 450 corresponding to the first satisfied rule in the ordered list of the profile 450. Finally, the user is presented with the calculated recommendation score for each program during step 740, before program control terminates.

It is to be understood that the embodiments and variations shown and described herein are merely illustrative of the principles of this invention and that various modifications may be implemented by those skilled in the art without departing from the scope and spirit of the invention.

What is claimed is:

1. A method for recommending one or more available items, comprising the steps of:
obtaining a history of selecting one or more available items by at least one third party; and
generating a recommendation score for at least one of said available items based on said third party selection history.

2. The method of claim 1, further comprising the step of partitioning said third party selection history into clusters containing similar items.

3. The method of claim 2, wherein said obtaining step further comprises the step of receiving a user selection of one or more of said clusters of similar items.

4. The method of claim 1, wherein said one or more items are programs.

5. The method of claim 1, wherein said one or more items are content.

6. The method of claim 1, wherein said one or more items are products.

7. A method for maintaining a user profile indicating preferences of a user, comprising the steps of:
partitioning a third party selection history into clusters containing similar items;
receiving a selection from said user of at least one of said clusters of similar items; and
updating said user profile using said selected clusters.

8. The method of claim 7, wherein said user profile is associated with a program content recommender.

9. The method of claim 8, wherein said user profile indicates viewing preferences of said user.

10. The method of claim 7, wherein said step of updating said user profile further comprises the steps of updating a selection history of said user with items from said selected clusters and updating said user profile using said updated selection history.

11. The method of claim 7, wherein said one or more items are programs.

12. The method of claim 7, wherein said one or more items are content.

13. The method of claim 7, wherein said one or more items are products.

14. A system for recommending one or more available items, comprising:
a memory for storing computer readable code; and
a processor operatively coupled to said memory, said processor configured to:
obtain a history of selecting one or more available items by at least one third party; and
generate a recommendation score for at least one of said available items based on said third party selection history.

15. The system of claim 14, wherein said processor is further configured to partition said third party selection history into clusters containing similar items.

16. The system of claim 15, wherein said processor is further configured to receive a user selection of one or more of said clusters of similar items.

17. A system for recommending one or more available items, comprising:
means for obtaining a history of selecting one or more available items by at least one third party; and
means for generating a recommendation score for at least one of said available items based on said third party selection history.

18. A system for maintaining a user profile indicating preferences of a user, comprising:
a memory for storing computer readable code; and
a processor operatively coupled to said memory, said processor configured to:
partition a third party selection history into clusters containing similar items;
receive a selection from said user of at least one of said clusters of similar items; and
update said user profile using said selected clusters.

19. The system of claim 18, wherein said user profile is associated with a program content recommender.

20. The system of claim 18, wherein said user profile indicates viewing preferences of said user.

21. The system of claim 18, wherein said step of updating said user profile further comprises the steps of updating a selection history of said user with items from said selected clusters and updating said user profile using said updated selection history.

22. An article of manufacture for recommending one or more available items, comprising:
a computer readable medium having computer readable code means embodied thereon, said computer readable program code means comprising:
a step to obtain a history of selecting one or more available items by at least one third party; and
a step to generate a recommendation score for at least one of said available items based on said third party selection history.

23. An article of manufacture for maintaining a user profile indicating preferences of a user, comprising:
a computer readable medium having computer readable code means embodied thereon, said computer readable program code means comprising:
a step to partition a third party selection history into clusters containing similar items;
a step to receive a selection from said user of at least one of said clusters of similar items; and
a step to update said user profile using said selected clusters.
